(19) United States
(12) Patent Application Publication
(10) Pub. No.: US 2025/0253708 A1
(43) Pub. Date: Aug. 7, 2025

(54) Techniques for Wireless Charging Negotiation

(71) Applicant: Apple Inc., Cupertino, CA (US)

(72) Inventors: Srinivasa V Thirumalai Ananthan Pillai, Santa Clara, CA (US); Zaid A AbuKhalaf, Sunnyvale, CA (US); Jukka-pekka J Sjoeroos, Cupertino, CA (US); Alin I Gherghescu, Campbell, CA (US); Herve Grabas, Mountain View, CA (US)

(21) Appl. No.: 18/968,874

(22) Filed: Dec. 4, 2024

Related U.S. Application Data
(60) Provisional application No. 63/644,129, filed on May 8, 2024.
(60) Provisional application No. 63/550,469, filed on Feb. 6, 2024.

(51) Int. Cl. H02J 50/10; H02J 7/00; H02J 50/80

(52) U.S. Cl. CPC H02J 50/10; H02J 7/00712; H02J 50/80; H02J 2207/20

(57) ABSTRACT

A wireless power transfer system may include a power transmitting device for transferring wireless power to a power receiving device. The power transmitting device may include control circuitry configured to negotiate a power level with the power receiving device and to detect whether the power level crosses a threshold, is equal to one of a plurality of power levels, or is within one of a plurality of ranges of power levels. Based on the results of such determination, the power transmitting device may selectively adjust a power adapter that is coupled to the power transmitting device.

This application claims the benefit of U.S. Provisional Patent Application No. 63/550,469, filed Feb. 6, 2024, and U.S. Provisional Patent Application No. 63/644,129, filed May 8, 2024, which are hereby incorporated by reference herein in their entireties.

### FIELD

This relates generally to power systems, and, more particularly, to wireless power systems for charging electronic devices.

### BACKGROUND

In a wireless charging system, a wireless power transmitting device such as a charging puck can transmit wireless power to a wireless power receiving device such as a battery-powered, portable electronic device. The wireless power transmitting device has a coil that produces electromagnetic flux. The wireless power receiving device has a coil and a rectifier that uses electromagnetic flux produced by the transmitter to generate direct-current power that can be used to power electrical loads in the battery-powered, portable electronic device.

The wireless power transmitting device can transmit wireless power to the wireless power receiving device at a given power level. Transmitting wireless power from the wireless power transmitting device to the wireless power receiving device at the given power level at all times can be inefficient.

### SUMMARY

An aspect of the disclosure provides an electronic device that includes a wireless power transfer coil configured to transmit wireless power to a wireless power receiving device, power transmitting circuitry configured to receive an input voltage from a power adapter and to drive corresponding alternating-current (AC) signals through the wireless power transfer coil, and control circuitry. The control circuitry can be configured to negotiate a power level with the wireless power receiving device, to detect whether the negotiated power level crosses a threshold level (e.g., whether the power level falls below the threshold level), and to direct the power adapter to switch from operating in a first power delivery mode to operating in a second power delivery mode in response to detecting that the negotiated power level crosses the threshold level. The input voltage received by the power transmitting circuitry can have a first voltage level when the power adapter is operated in the first power delivery mode and can have a second voltage level different than the first voltage level when the power adapter is operated in the second power delivery mode. The power transmitting circuitry can be operable in a plurality of different power modes, where the negotiated power level exhibits different values corresponding to the plurality of different power modes. The power adapter can be operable in three or more different power delivery modes, where the input voltage has different voltage levels.

An aspect of the disclosure provides a method of operating an electronic device that is removably coupled to a power adapter. The method can include: negotiating a power level with a wireless power receiving device, detecting whether the negotiated power level is equal to a first power level or is within a first range of power levels, directing the power adapter to operate in a first power delivery mode that delivers a first voltage to one or more inputs of the electronic device in response to detecting that the negotiated power level is equal to a first power level or is within a first range of power levels, and transmitting wireless power to the wireless power receiving device in accordance with the negotiated power level. The method can further include detecting whether the negotiated power level is equal to a second power level or is within a second range of power levels, and directing the power adapter to operate in a second power delivery mode that delivers a second voltage, different than the first voltage, to the one or more inputs of the electronic device in response to detecting that the negotiated power level is equal to the second power level or is within the second range of power levels. The method can further include detecting whether the negotiated power level is equal to a third power level or is within a third range of power levels, and directing the power adapter to operate in a third power delivery mode that delivers a third voltage, different than the first and second voltages, to the one or more inputs of the electronic device in response to detecting that the negotiated power level is equal to the third power level or is within the third range of power levels.

An aspect of the disclosure provides a wireless power transfer system. The system can include a power receiving device, a power adapter, and a power transmitting device coupled to the power adapter. The power transmitting device can include a wireless power transfer coil configured to transmit wireless power to the power receiving device, power transmitting circuitry configured to receive an input voltage from the power adapter and to drive corresponding alternating-current (AC) signals through the wireless power transfer coil, and control circuitry. The control circuitry can be configured to negotiate a power level with the power receiving device, to determine whether the power level crosses a threshold, is equal to one of a plurality of power levels, or is within one of a plurality of ranges of power levels, and to control or adjust the power adapter based on such determination.

An aspect of the disclosure provides a power transmitting device that includes a wireless power transfer coil configured to transmit wireless power to a power receiving device, power transmitting circuitry configured to receive an input voltage from a power adapter and to drive corresponding alternating-current (AC) signals through the wireless power transfer coil; and control circuitry configured to negotiate a target operating characteristic with the power receiving device and direct the power adapter to adjust the input voltage based on the target operating characteristic.

An aspect of the disclosure provides a method of operating a power transmitting device removably coupled to a power adapter. The method can include negotiating a target operating characteristic with a power receiving device, directing the power adapter to deliver an input voltage having a voltage level that is based on the target operating characteristic, where the input voltage is delivered to one or more inputs of the power transmitting device, and transmitting wireless power to the power receiving device while the input voltage is being delivered to the one or more inputs of the power transmitting device.

An aspect of the disclosure comprises a system that includes a power receiving device, a power adapter, and a power transmitting device coupled to the power adapter. The power transmitting device can include a wireless power transfer coil configured to transmit wireless power to the power receiving device, power transmitting circuitry configured to receive an input voltage from the power adapter and to drive corresponding alternating-current (AC) signals through the wireless power transfer coil, and control circuitry configured to receive information from the power receiving device and direct the power adapter to adjust the input voltage based on the information received from the power receiving device.

### BRIEF DESCRIPTION OF THE DRAWINGS

FIG. 1 is a diagram of an illustrative wireless power transfer system that includes a wireless power transmitting device and a wireless power receiving device in accordance with some embodiments.

FIG. 2 is a diagram showing wireless power transmitting and receiving circuitry in accordance with some embodiments.

FIG. 3 is a side view of an illustrative wireless power transmitting device such as a wireless charging puck connected to a power adapter via a cable in accordance with some embodiments.

FIG. 4 is a flowchart of illustrative steps for operating a wireless power transfer system of the type shown in FIGS. 1-3 in accordance with some embodiments.

FIG. 5 is a diagram showing how different power levels can trigger the use of different power transmitting device input voltages in accordance with some embodiments.

FIG. 6 is a flowchart of illustrative steps for operating a wireless power transfer system of the type shown in FIGS. 1-3 in accordance with some embodiments.

FIG. 7 is a diagram showing how different power modes can trigger the use of different power transmitting device input voltages in accordance with some embodiments.

FIG. 8 is a diagram showing how different rectifier voltage levels can trigger the use of different power transmitting device input voltages in accordance with some embodiments.

FIG. 9 is a diagram showing how different rectifier power levels can trigger the use of different power transmitting device input voltages in accordance with some embodiments.

### DETAILED DESCRIPTION

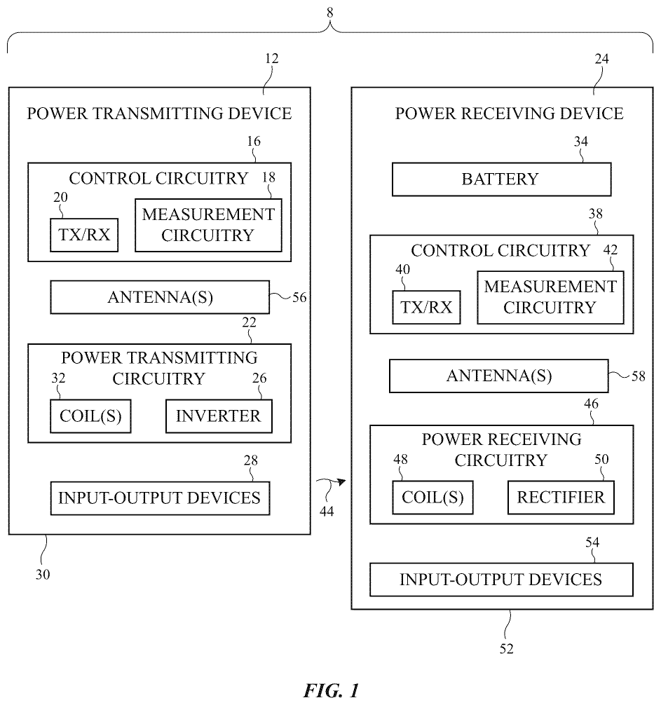

An illustrative wireless power transfer system, sometimes also referred to as a wireless power system or a wireless charging system, is shown in FIG. 1. As shown in FIG. 1, wireless transfer power system 8 may include one or more wireless power transmitting devices such as wireless power transmitting device 12 and one or more wireless power receiving devices such as wireless power receiving device 24. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing 52 for PRX device 24. Exemplary control circuitry 16 and control circuitry 38 are used in controlling the operation of wireless power transfer (WPT) system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of wireless power transfer system 8.

Control circuitry in system 8 (e.g., control circuitry 16 and/or 38) is configured to perform operations in system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 38.

PTX device 12 may be a wireless charging mat or puck that is connected to a power adapter or other equipment by a cable, can optionally include power adapter circuitry, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct-current (DC) power converter that converts AC power from a wall outlet or other power source into DC power. If desired, PTX device 12 may include a DC-DC power converter such as a boost converter for converting the DC power between different DC voltages. The DC-DC power converter may be considered part of power transmitting circuitry 22. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transmitting coils such as wireless power transfer coil(s) 32. These coil drive signals cause coil(s) 32 to transmit or transfer wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any desired frequency (e.g., 100-400 kHz, 1-100 MHz, between 1.7 MHz and 1.8 MHz, less than 2 MHz, between 100 kHz and 2 MHz, etc.). Rectifier circuitry such as rectifier circuitry 50, which contains rectifying components such as synchronous rectification transistors arranged in a bridge network, converts received AC signals (received alternating-current signals associated with wireless power signals 44) from one or more coils 48 into DC voltage signals for powering PRX device 24. Wireless power signals 44 are sometimes referred to herein as wireless power 44 or wireless charging signals 44. Coils 32 are sometimes referred to herein as wireless power transfer coils 32, wireless charging coils 32, or wireless power transmitting coils 32. Coils 48 are sometimes referred to herein as wireless power transfer coils 48, wireless charging coils 48, or wireless power receiving coils 48.

The DC voltage produced by rectifier circuitry 50 (sometime referred to as rectifier output voltage Vrect) may be used in charging a battery such as battery 34 and may be used in powering other components in PRX device 24 such as control circuitry 38, input-output (I/O) devices 54, etc. PTX device 12 may also include input-output devices such as input-output devices 28. Input-output devices 54 and/or input-output devices 28 may include input devices for gathering user input and/or making environmental measurements and may include output devices for providing a user with output.

As examples, input-output devices 28 and/or input-output devices 54 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 54 may also include sensors for gathering input from a user and/or for making measurements of the surroundings of WPT system 8.

The example in FIG. 1 of PRX device 24 including battery 34 is merely illustrative. If desired, an electronic device may include a supercapacitor to store charge instead of a battery. For example, PRX device 24 may include a supercapacitor in place of battery 34. Battery 34 may therefore sometimes be referred to as power storage device 34 or supercapacitor 34.

PTX device 12 and PRX device 24 may communicate wirelessly using in-band or out-of-band communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. When PTX 12 sends in-band data to PRX 24, wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. When PRX 24 sends in-band data to PTX 12, wireless transceiver (TX/RX) circuitry 40 may modulate wireless charging signal 44 to impart FSK or ASK communications, and wireless transceiver circuitry 20 may demodulate the wireless charging signal 44 to obtain the data that is being communicated.

Implementations using out-of-band communication may utilize, for example, hardware antenna structures and communication protocols such as Bluetooth or NFC to communicate out-of-band data between PTX device 12 and PRX device 24. Power may be conveyed wirelessly between coils 32 and 48 concurrently with the out-of-band data transmissions. Wireless transceiver circuitry 20 may wirelessly transmit and/or receive out-of-band signals to and/or from PRX device 24 using an antenna such as antenna 56. Wireless transceiver circuitry 40 may wirelessly transmit and/or receive out-of-band signals to and/or from PTX device 12 using an antenna such as antenna 58.

Control circuitry 16 in PTX device 12 has measurement circuitry 18 that may be used to perform measurements of one or more characteristics external to PTX device 12. For example, measurement circuitry 18 may detect external objects on or adjacent the charging surface of the housing of PTX device 12. While shown in FIG. 1 as being separate from power transmitting circuitry 22 for the sake of clarity, measurement circuitry 18 may form a part of power transmitting circuitry 22 if desired.

Measurement circuitry 18 may detect foreign objects such as coils, paper clips, and other metallic objects, may detect the presence of PRX device 24 (e.g., circuitry 18 may detect the presence of one or more coils 48 and/or magnetic core material associated with coils 48), and/or may detect the presence of other power transmitting devices in the vicinity of PTX device 12 and/or WPT system 8. Measurement circuitry 18 may also be used to make sensor measurements using a capacitive sensor, may be used to make temperature measurements, and/or may otherwise be used in gathering information indicative of whether a foreign object, power transmitting device, power receiving device, or other external object (e.g., PRX device 24) is present on or adjacent to the coil(s) 32 of PTX device 12. If desired, PRX device 24 may include measurement circuitry 42. Measurement circuitry 42 may perform one or more of the measurements performed by measurement circuitry 18 (e.g., for or using coil(s) 48 on PRX device 24).

Each one of housing 30 and housing 52 may be formed from plastic, metal, fiber-composite materials such as carbon-fiber materials, wood and other natural materials, glass, other materials, and/or combinations of two or more of these materials.

The example in FIG. 1 of PTX 12 transmitting wireless power and PRX 24 receiving wireless power is merely illustrative. PTX 12 may optionally be capable of receiving wireless power signals using coil(s) 32 and PRX 24 may optionally be capable of transmitting wireless power signals using coil(s) 48. When a device is capable of both transmitting and receiving wireless power signals, the device may include both an inverter and a rectifier.

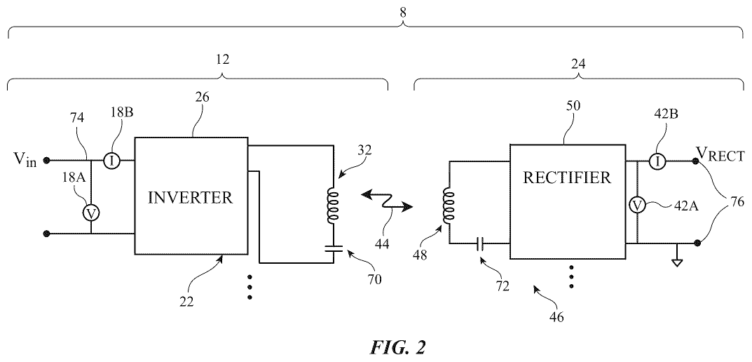

FIG. 2 is a circuit diagram of illustrative wireless power transfer circuitry for system 8. As shown in FIG. 2, switching circuitry 22 may include inverter circuitry such as one or more inverters 26 or other drive circuitry that produces wireless power signals that are transmitted through an output circuit that includes one or more coils 32 and capacitors such as capacitor 70. In some embodiments, PTX device 12 may include multiple individually controlled inverters 26, each of which supplies drive signals to a respective coil 32. In other embodiments, an inverter 26 can be shared between multiple coils 32 using switching circuitry.

During operation, control signals for inverter(s) 26 are provided by control circuitry 16 at one or more control inputs 74. As an example, control input 74 can receive an input voltage Vin from a power adapter. Input voltage Vin received at one or more control inputs 74 of PTX device 12 from a separate power adapter (e.g., an external wall power adapter) is sometimes referred to and defined herein as a “power transmitting device input voltage.” A single inverter 26 and single coil 32 is shown in the example of FIG. 2, but multiple inverters 26 and multiple coils 32 may be used, if desired. In a multiple coil configuration, switching circuitry (e.g., multiplexer circuitry) may be used to couple a single inverter 26 to multiple coils 32 and/or each coil 32 may be coupled to a respective inverter 26. During wireless power transmission operations, transistors in one or more selected inverters 26 are driven by AC control signals from control circuitry 16. The relative phase between the inverters may be adjusted dynamically (e.g., a pair of inverters 26 may produce output signals in phase or out of phase).

The application of drive signals using inverter(s) 26 (e.g., transistors or other switches in circuitry 22) causes the output circuits formed from selected coils 32 and capacitors 70 to produce alternating-current electromagnetic fields (signals 44) that are received by wireless power receiving circuitry 46 using a wireless power receiving circuit formed from one or more coils 48 and one or more capacitors 72 in device 24.

Rectifier circuitry 50 is coupled to one or more coils 48 and converts received power from AC to DC and supplies a corresponding direct current output voltage Vrect across rectifier output terminals 76 for powering load circuitry in device 24 (e.g., for charging battery 34, for powering a display and/or other input-output devices 54, and/or for powering other components).

FIG. 2 shows how measurement circuitry 18 within PTX 12 may include one or more voltage sensors such as voltage sensor 18A and one or more current sensors such as current sensor 18B. Additionally, measurement circuitry 42 within PRX 24 may include one or more voltage sensors such as voltage sensor 42A and one or more current sensors such as current sensor 42B. The voltage and current sensors within system 8 may be used to determine power levels within the system. The specific locations of sensors 18A, 18B, 42A, and 42B (on the DC sides of inverter 26 and rectifier 50 respectively) in FIG. 2 are merely illustrative. In general, voltage and current sensors may be positioned at any desired positions within the power transmitting circuitry 22 and the power receiving circuitry 46 (e.g., on the AC sides of inverter 26 and rectifier 50 if desired).

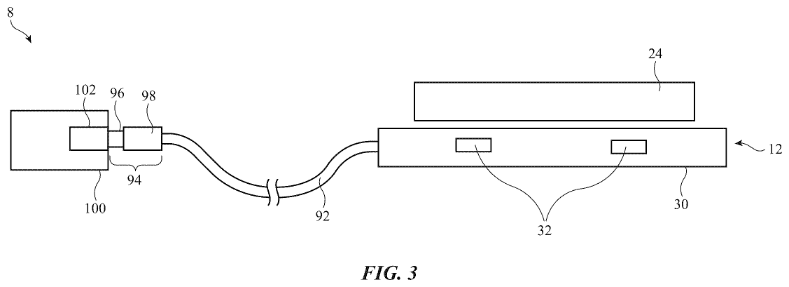

FIG. 3 is a cross-sectional side view of system 8. As shown in FIG. 3, device 12 has a device housing 30 (e.g., a disk-shaped puck housing formed form polymer, other dielectric material, and/or other materials). Device housing 30 may house a device microcontroller for communicating with a plug 94, DC-DC power converter circuitry such as a step-down voltage converter (e.g., a buck converter) or a step-up voltage converter (e.g., a boost converter), voltage regulator circuitry such as a low-dropout (LDO) regulator, wireless power transmitting circuitry such as inverter 26 (see FIG. 2), coil(s) 32, capacitor 70, foreign object detection circuitry for detecting the presence of a foreign object (e.g., a metal coin or other object that can potentially interfere with the wireless charging of power receiving device 24), near-field communications (NFC) circuitry for communicating with power receiving device 24, over-temperature protection (OTP) circuitry such as a temperature sensor, debug circuitry, filter circuitry, magnetic alignment structures such as magnets for attracting device 24 during charging operations, and/or other power transmitting device components.

Cable 92 is coupled to device housing 30 and provides power to coil(s) 32. One end of cable 92 may be pigtailed to housing 30. The opposing end of cable 92 is terminated using plug 94. Plug 94 has a boot portion 98 sometimes referred to as the “boot” of the plug. Cable 92 and plug 94 may be considered part of PTX 12 or may be considered a separate component from PTX 12. Boot 98, which may sometimes be referred to as a connector boot, may be formed from polymer, metal, and/or other materials and may have an interior region configured to house electrical components (e.g., integrated circuits, discrete components such as transistors, printed circuits, etc.). Boot 98 has a first end connected to cable 92 and a second end connected to a connector portion 96 (sometimes referred to as the “connector” of the plug). Connector 96 may include 24 pins, 10-30 pins, 10 or more pins, 20 or more pins, 30 or more pins, 40 or more pins, 50 or more pins, or any suitable number of pins supported within a connector housing. The pins within connector 96 are configured to mate with corresponding pins in port 102 of external equipment such as device 100.

Device 100 may be a stand-alone power adapter that converts alternating-current (AC) power to direct-current (DC) power, an electronic device such as a computer, or other equipment that provides DC power to plug 94 through port 102. Port 102 may be, for example, a USB port (e.g., a USB type-A port, a USB type-C port, a USB 4.0 port, a USB 3.0 port, a USB 2.0 port, a micro-USB port, etc.) or a Lightning connector port. Device 100 may be a USB adapter configured to transform AC power from a wall outlet (e.g., a 110-120V or 220-240V outlet) to DC power (e.g., 5V, 9V, 12V, 15V, or 20V DC input) for powering USB-type devices. Plug 96 having a connector protruding from boot 98 may be referred to as a male plug. Plug 96 may be a reversible plug (i.e., a plug that may be mated with a corresponding connector port in at least two different and symmetrical orientations).

During operation of system 8, power receiving device 24 may be placed on the charging surface of power transmitting device 12. Device 24 and device 12 may have magnets (and/or magnetic material such as iron). For example, device 24 may have a magnet and device 12 may have a corresponding mating magnet. These magnets attract each other and thereby hold devices 12 and 24 together during charging.

Boot 98 may have a boot housing that houses various electrical components. The boot housing may house a boot microcontroller for communicating with the device microcontroller in housing 30, DC-DC power converter circuitry such as a step-up voltage converter (e.g., a boost converter), voltage regulator circuitry such as a low-dropout (LDO) regulator, electronic fuse circuitry such as an e-fuse or fuse for providing overcurrent protection when detecting short circuits, overloading, mismatched loads, or other device failure events, filter circuitry, and/or other boot components. In one illustrative arrangement, inverter 26 may be formed in boot 98 instead of in housing 30.

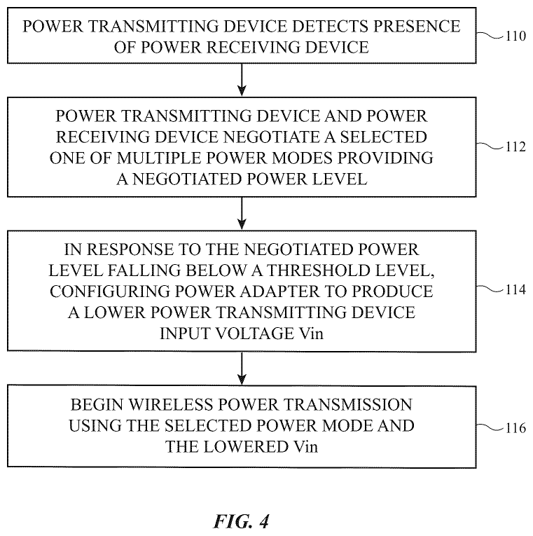

In accordance with an embodiment, the power transmitting device 12 may be operable to transfer wireless power to the power receiving device 24 by employing one of a plurality of different power modes. FIG. 4 is a flowchart of illustrative steps for operating a wireless power transfer system 8 of the type described in connection with FIGS. 1-3. During the operations of block 110, power transmitting device 12 can operate in a foreign object detection (FOD) mode and can detect the presence of a power receiving device 24 on its charging surface. As an example, power transmitting device 12 may use low-power external object detection or analog pings to detect the presence of a foreign object. As another example, power transmitting device 12 may perform impedance measurements, impulse response measurements, and/or other suitable foreign object detection schemes to detect when device 24 has been placed on the charging surface of device 12.

In response to detecting the presence of a valid power receiving device 24 on its charging surface, power transmitting device 12 can perform power negotiation operations with power receiving device 24 (see operations of block 112). In some embodiments, the power receiving device 24 can negotiate with power transmitting device 12 a desired amount of power based on its power requirements (e.g., based on its current battery level or based on current load conditions). Power transmitting device 12 can be configured to output wireless power to power receiving device 24 by operating in one of a plurality of different power modes. For example, power transmitting device 12 might be operable in n different power modes, where n represents an integer that is 2 or more, 3 or more, 4 or more, 5-10, or greater than 10.

When power transmitting device 12 is configured to operate in a first power mode (e.g., to provide a first power level profile), device 12 may be configured to output wireless power to power receiving device 24 at a first negotiated power level (or at power levels less than a first maximum power level). When power transmitting device 12 is configured to operate in a second power mode (e.g., to provide a second power level profile), device 12 may be configured to output wireless power to power receiving device 24 at a second negotiated power level (or at power levels less than a second maximum power level) different than the first negotiated power level. When power transmitting device 12 is configured to operate in a third power mode (e.g., to provide a third power level profile), device 12 may be configured to output wireless power to power receiving device 24 at a third negotiated power level (or at power levels less than a third maximum power level) different than the first and second negotiated power levels, and so on. During the operations of block 112, power transmitting device 12 and power receiving device 24 can negotiate a selected one of multiple (n) power modes that provides a negotiated wireless power transfer power level. A power mode that provides a relatively low power level can be referred to as a low power mode, whereas a power mode that provides a relatively high power level can be referred to as a high power mode.

During the operations of block 114, power transmitting device 12 can monitor the negotiated power level and monitor the negotiated power level with respect to a certain threshold power level. For example, power transmitting device 12 can determine whether the negotiated power level falls below some threshold or exceeds some threshold. Power transmitting device 12 can determine the negotiated power level based on measurement data (e.g., using measurement circuitry 18 in FIG. 1 or sensors 18A and 18B in FIG. 2) or based on knowledge of the currently selected power mode (i.e., not based on measurement or sensor data). For example, device 12 can infer that the negotiated power level is at a first power level based on a priori knowledge that device 12 is operating in the first power mode. As another example, device 12 can infer that the negotiated power level is at a second power level based on a priori knowledge that device 12 is operating in the second power mode. As another example, device 12 can infer that the negotiated power level is at a third power level based on a priori knowledge that device 12 is operating in the third power mode, and so on.

In response to determining that the negotiated power level is (or falls) below a threshold level, power transmitting device 12 may configure or direct power adapter 100 to produce a lower power transmitting device input voltage Vin. For example, power transmitting device 12 may send a USB Power Delivery compliant message to power adapter 100. As described above in connection with FIG. 2, voltage Vin represents a voltage that is received at one or more inputs of power transmitting device 12. Exemplary threshold levels are 3, 4, 5, 6, 7, 8, 9, and 10 watts (W). As another example, the threshold level might be some value between 2 W and 7 W. As other examples, the threshold level might be some power value less than 4 W, less than 5 W, less than 6 W, less than 7 W, less than 8 W, less than 9 W, or less than 10 W. The threshold level, sometimes referred to as a threshold power level, can be fixed or adjustable.

In accordance with some embodiments, power adapter 100 can be operable in different power adapter (power delivery) modes for producing different Vin levels. In exemplary device configurations in which power adapter 100 has a USB port 102 (e.g., a USB type-C port, a USB 4.0 port, a USB 3.0 port, a USB 2.0 port, a micro-USB port, etc.), power adapter 100 may be configured to deliver one or more voltage levels in accordance with the USB Power Delivery (PD) specification. For example, power adapter 100 can be configured to operate in a first power adapter mode that produces or delivers a Vin of 9 V, to operate in a second power adapter mode that produces or delivers a reduced Vin of 5 V, and to operate in a third power adapter mode that produces or delivers an elevated Vin of 13 V. The various power adapter modes are thus sometimes referred to herein as power delivery modes. This example is illustrative. In general, power adapter 100 can be operable in a plurality of power delivery modes configured to produce two or more Vin levels, three or more Vin levels, four or more Vin levels, five to ten Vin levels, or more than ten Vin levels. In the example of FIG. 4, in response to power transmitting device 12 detecting that the negotiated power level falls below a threshold level of 4 W, power transmitting device 12 may direct power adapter to switch from producing a Vin of 9 V to a reduced Vin of 5 V to accommodate a lower power profile. This is exemplary.

During the operations of block 116, power transmitting device 12 can begin transmitting wireless power to power receiving device 24 in accordance with the negotiated power level. In other words, power transmitting device 12 may operate in an active wireless power transfer mode. During the active wireless power transfer mode, device 12 may concurrently perform in-band communications with device 24 (e.g., device 12 may use at transmitter in transceiver 20 to transmit FSK packets to a receiver in transceiver 40, whereas device 24 may use a data transmitter in transceiver 40 to transmit ASK packets to a receiver in transceiver 20 while wireless power is being transferred from device 12 to device 24).

Power transmitting device 12 may be operated in the active wireless power transfer mode to charge battery 34 of device 24 until a state of charge (SOC) or battery level of battery 34 is deemed to be full. Power transfer operations can be halted when the state of charge of battery 34 has exceeded a target charging threshold, when the temperature of battery 34 has exceeded a predetermined temperature threshold, or when device 12 otherwise determines that power transmission should be halted. The target charging threshold may, for example, be equal to 80%, 90%, 95%, 99%, or other suitable target threshold value for indicating that battery 58 is near the end of charge or is fully charged. Pausing or halting power transfer operations when battery 34 is fully charged can help reduce power consumption at device 12 while preventing unnecessary charging at device 24 (e.g., constantly topping off battery 34 to 100% state of charge may be excessive especially when device 24 is idle).

The operations of FIG. 4 are illustrative. The operations of power transmitting device 12 can be at least partially carried out or orchestrated by control circuitry 16 of device 12 (see FIG. 1). Operating system 8 in this way by dynamically changing the power adapter (delivery) mode to selectively reduce Vin based on the negotiated wireless power transfer level can be technically advantageous and beneficial to allow a DC-DC converter (e.g., a boost converter) within power transmitting device 12 to boost Vin more efficiently, which mitigates the need for a lossy phase shift modulation operation to step down an overly high Vin while reducing electromagnetic interference and power consumption. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

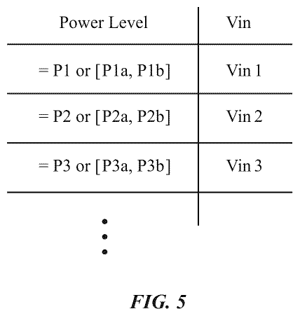

The operations of FIG. 4 in which power transmitting device 12 negotiates a different power delivery mode with power adapter 100 when the monitored/negotiated power level falls below a threshold level are illustrative. In other embodiments, the monitored power level can be compared to two or more different threshold levels to determine/detect whether to configure power adapter 100 in one of a plurality of different power delivery modes. In accordance with another embodiment, FIG. 5 is a diagram showing how different power levels can trigger the use of different voltages Vin output by power adapter 100. As shown in FIG. 5, in response to power transmitting device 12 determining that the negotiated power level is equal to (matches) a first power level P1 or is within a first range of power levels between a lower bound P1a and an upper bound P1b, power adapter 100 may be configured to produce or deliver a power transmitting device input voltage of Vin1. The first range of power levels can optionally include a single power level (e.g., if P1a is equal to P1b).

In response to power transmitting device 12 determining that the negotiated power level is equal to (matches) a second power level P2 different than P1 or is within a second range of power levels between a lower bound P2a and an upper bound P2b, power adapter 100 may be configured to produce or deliver a power transmitting device input voltage of Vin2 that is different than Vin1. The second range of power levels may be non-overlapping with the first range of power levels (i.e., there is no intersection between the two ranges). The second range of power levels can optionally include a single power level (e.g., if P2a is equal to P2b).

In response to power transmitting device 12 determining that the negotiated power level is equal to (matches) a third power level P3 different than P1 and P2 or is within a third range of power levels between a lower bound P3a and an upper bound P3b, power adapter 100 may be configured to produce or deliver a power transmitting device input voltage of Vin3 that is different than Vin1 and Vin2. The third range of power levels may be non-overlapping with the first and second ranges of power levels (i.e., there is no intersection between the three ranges). The third range of power levels can optionally include a single power level (e.g., if P3a is equal to P3b). The example of FIG. 5 in which power transmitting device 12 can negotiate with power adapter 100 to deliver three different Vin levels based on at least three different power level ranges is illustrative. In general, system 8 can be configured to deliver two or more different Vin levels based on a comparison of the negotiated power level with a single threshold power level, two or more threshold power levels, a single range of power levels, or two or more ranges of power levels.

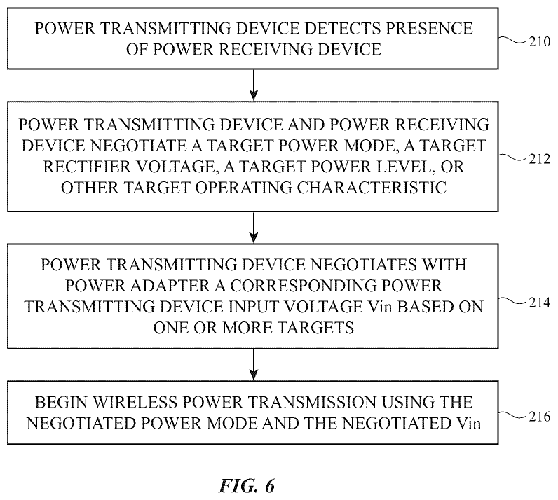

In accordance with another embodiment, the power transmitting device 12 may be operable to transfer wireless power to the power receiving device 24 by employing one of a plurality of different power modes. FIG. 6 is a flowchart of illustrative steps for operating a wireless power transfer system 8 of the type described in connection with FIGS. 1-3. During the operations of block 210, power transmitting device 12 can operate in a foreign object detection (FOD) mode and can detect the presence of a power receiving device 24 on its charging surface. As an example, power transmitting device 12 may use low-power external object detection or analog pings to detect the presence of a foreign object. As another example, power transmitting device 12 may perform impedance measurements, impulse response measurements, and/or other suitable foreign object detection schemes to detect when device 24 has been placed on the charging surface of device 12.

In response to detecting the presence of a valid power receiving device 24 on its charging surface, power transmitting device 12 can perform power negotiation operations with power receiving device 24 (see operations of block 212). In some embodiments, the power receiving device 24 can negotiate with power transmitting device 12 a desired amount of power based on its power requirements (e.g., based on its current battery level or based on current load conditions). During this negotiation phase, power receiving device 24 can transmit one or more messages optionally in the form of packets, via in-band communications, that include certain target operating characteristics or parameters for the ensuing wireless power transfer operation. Such type of message(s) or packet(s) being transmitted during the negotiation phase are sometimes referred to as negotiation messages/packets or wireless power transfer negotiation messages/packets.

In one embodiment, a negotiation packet could indicate or specify a target power mode that is currently desired by the power receiving device 24. The target power mode can be selected from a plurality of n different power modes, where n represents an integer that is 2 or more, 3 or more, 4 or more, 5-10, or greater than 10. For example, the power transmitting device 12 can be operable in at least a low (light) power mode, a nominal (medium or intermediate) power mode, and a high power mode. When operated in the low power mode, power transmitting device 12 may be configured to deliver a first amount of wireless power to power receiving device 24, where the first amount of wireless power could be around 5 W, less than 5 W, less than 6 W, less than 7 W, or other low power level.

When operated in the high power mode, power transmitting device 12 may be configured to deliver a second amount of wireless power to power receiving device 24, where the second amount of wireless power could be around 12 W, around 15 W, around 20 W, greater than 10 W, 10-15 W, 15-20 W, 20-25 W, or other high power level. When operated in the nominal power mode, power transmitting device 12 may be configured to deliver a third amount of wireless power to power receiving device 24, where the third amount of power is at a level between the first amount of wireless power produced by the low power mode and the second amount of wireless power produced by the high power mode.

In some embodiment, the nominal power mode can be used when the power transmitting device 12 first begins transmitting wireless power to the power receiving device 24. The low power mode can be negotiated by power receiving device 24 when a battery level at the power receiving device exceeds a first battery threshold (e.g., when a state of charge of battery 34 in FIG. 1 is high or almost full). The high power mode can be negotiated by power receiving device 24 when the battery level at the power receiving device is below a second battery threshold (e.g., when the state of charge of battery 34 is low or when the power receiving device is otherwise requiring more power transfer). The first battery threshold may be greater than the second battery threshold.

In another embodiment not mutually exclusive with the aforementioned embodiments, a negotiation packet could indicate or specify a target operating parameter such as a target rectifier voltage Vrect that is currently desired by the power receiving device 24. Rectifier voltage Vrect can refer to and be defined herein as the voltage detected at the output of rectifier 50 (see FIG. 2, as measured by voltage sensor 42A). The current at the output of rectifier 50, as measured by current sensor 42B, can be defined as the rectifier current or rectifier output current Irect. Voltage Vrect can sometimes be referred to as a rectified voltage or a power receiving circuitry output voltage. The target rectifier voltage can be selected from a plurality of m different Vrect voltages, where m represents an integer that is 2 or more, 3 or more, 4 or more, 5-10, or greater than 10. For example, power receiving device 24 might wish to target a low Vrect level, a nominal (medium or intermediate) Vrect level, or a high Vrect level. The low Vrect level can be around 12.5 V, less than 13 V, less 10-15 V, less than 15 V, less than 10 V, or other suitable low voltage level. The high Vrect level can be around 18 V, 18-20 V, 20-25 V, greater than 20 V, greater than 25 V, greater than 30 V, or other suitable high voltage level. The nominal Vrect level can be greater than the low Vrect level and less than the high Vrect level.

In another embodiment not mutually exclusive with the aforementioned embodiments, a negotiation packet could indicate or specify a target operating parameter such as a target rectifier power Prect that is currently desired by the power receiving device 24. Rectifier power Prect can refer to and be defined herein as the power detected at the output of rectifier 50 (see FIG. 2, as measured by voltage sensor 42A and current sensor 42B). Power Prect can sometimes be referred to as a rectified power or a power receiving circuitry output power. The target rectifier power can be selected from a plurality of p different Prect levels, where p represents an integer that is 2 or more, 3 or more, 4 or more, 5-10, or greater than 10. For example, power receiving device 24 might wish to target a low Prect level, a nominal (medium or intermediate) Prect level, or a high Prect level. The low Prect level can be around 5 W, less than 5 W, less than 6 W, less than 7 W, or other low power level. The high Prect level can be around 12 W, around 15 W, around 20 W, greater than 10 W, 10-15 W, 15-20 W, 20-25 W, or other suitable high power level. The nominal Prect level can be greater than the low Prect level and less than the high Prect level.

These examples in which the power receiving device 24 negotiates for target operating characteristics such as a target power mode, a target rectifier voltage, and/or a target rectifier power are illustrative. If desired, power receiving device 24 can negotiate or request for other target operating characteristics, including but not limited to: a target output current (e.g., as measured by current sensor 42B in FIG. 2), a target wireless power transfer efficiency, a target wireless charging standard, a target wireless charging standard version number, a target electromagnetic compliance criteria, a target electromagnetic noise or interference criteria, and/or other target criteria desired during the ensuing wireless power transfer operation.

During the operations of block 214, the power transmitting device 12 can negotiate with power adapter 100 to produce a corresponding power transmitting device input voltage Vin based on the one or more targets identified during block 212. For example, power transmitting device 12 may send a USB Power Delivery compliant message to power adapter 100 (e.g., for directing power adapter 100 to adjust Vin to a new voltage level). As described above in connection with FIG. 2, voltage Vin represents a voltage that is received at one or more inputs of power transmitting device 12.

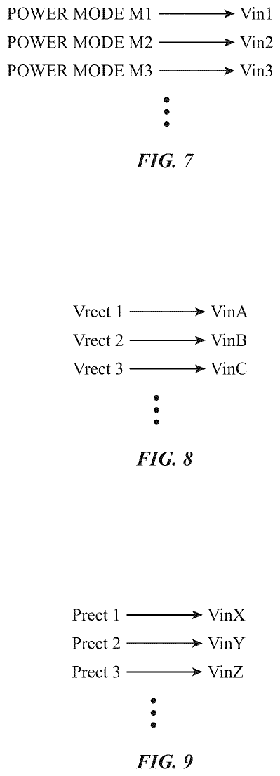

In the scenario where power receiving device 24 targets a specific power mode, power transmitting device 12 can negotiate a corresponding Vin with power adapter 100. FIG. 7 is a diagram showing how different power modes can trigger the use of different power transmitting device input voltages. As shown in FIG. 7, if a first power mode M1 is being targeted, then power transmitting device 12 might request for power adapter 100 to produce a first power transmitting device input voltage Vin1. The first power mode M1 might represent the low power mode, and Vin1 could be 5 V, 4-6 V, 3-7 V, less than 6 V, less than 7 V, less than 8 V, or other suitable low voltage. If a second power mode M2 is being targeted, then power transmitting device 12 might request for power adapter 100 to produce a second power transmitting device input voltage Vin2. The second power mode M2 might represent the high power mode, and Vin2 could be 15 V, 14-16 V, 13-17 V, greater than 10 V, greater than 13 V, 10-20 V, greater than 20 V, or other suitable high voltage. If a third power mode M3 is being targeted, then power transmitting device 12 might request for power adapter 100 to produce a third power transmitting device input voltage Vin3. The third power mode M3 might represent the nominal power mode, and Vin3 could be greater than Vin1 and less than Vin2. The example of FIG. 7 showing three different target power modes is illustrative. In general, power transmitting device 12 can be operable in any number of power modes, where each power mode can correspond with a different Vin level.

In the scenario where power receiving device 24 targets a specific Vrect, power transmitting device 12 can negotiate a corresponding Vin with power adapter 100. FIG. 8 is a diagram showing how different Vrect levels can trigger the use of different power transmitting device input voltages. As shown in FIG. 8, if a first rectifier voltage Vrect1 is being targeted, then power transmitting device 12 might request for power adapter 100 to produce a first power transmitting device input voltage VinA. VinA could be 5 V, 4-6 V, 3-7 V, less than 6 V, less than 7 V, less than 8 V, or other suitable low voltage. Voltage VinA may be equal to or different than Vin1 described in connection with FIG. 7. If a second rectifier voltage Vrect2 is being targeted, then power transmitting device 12 might request for power adapter 100 to produce a second power transmitting device input voltage VinB. Voltage VinB could be 15 V, 14-16 V, 13-17 V, greater than 10 V, greater than 13 V, 10-20 V, greater than 20 V, or other suitable high voltage. Voltage VinB may be equal to or different than Vin2 described in connection with FIG. 7. If a third rectifier voltage Vrect3 is being targeted, then power transmitting device 12 might request for power adapter 100 to produce a third power transmitting device input voltage VinC. Voltage VinC could be greater than VinA and less than VinB. Voltage VinC may be equal to or different than Vin3 described in connection with FIG. 7. The example of FIG. 8 showing three different target rectifier voltages is illustrative. In general, power transmitting device 12 can be operable to deliver any number of rectifier voltages, where each target Vrect can correspond with a different Vin level.

In the scenario where power receiving device 24 targets a specific Prect, power transmitting device 12 can negotiate a corresponding Vin with power adapter 100. FIG. 9 is a diagram showing how different Prect levels can trigger the use of different power transmitting device input voltages. As shown in FIG. 9, if a first rectifier power Prect1 is being targeted, then power transmitting device 12 might request for power adapter 100 to produce a first power transmitting device input voltage VinX. VinX could be 5 V, 4-6 V, 3-7 V, less than 6 V, less than 7 V, less than 8 V, or other suitable low voltage. Voltage VinX may be equal to or different than Vin1 of FIG. 7 and VinA of FIG. 8. If a second rectifier power Prect2 is being targeted, then power transmitting device 12 might request for power adapter 100 to produce a second power transmitting device input voltage VinY. Voltage VinY could be 15 V, 14-16 V, 13-17 V, greater than 10 V, greater than 13 V, 10-20 V, greater than 20 V, or other suitable high voltage. Voltage VinY may be equal to or different than Vin2 of FIG. 7 or VinB of FIG. 8. If a third rectifier power Prect3 is being targeted, then power transmitting device 12 might request for power adapter 100 to produce a third power transmitting device input voltage VinZ. Voltage VinZ could be greater than VinX and less than VinY. Voltage VinZ may be equal to or different than Vin3 of FIG. 7 or VinC of FIG. 8. The example of FIG. 9 showing three different target rectifier powers is illustrative. In general, power transmitting device 12 can be operable to deliver any number of rectifier power levels, where each target Prect can correspond with a different Vin level. These examples are illustrative.

During the operations of block 216, power transmitting device 12 can begin transmitting wireless power to power receiving device 24 in accordance with the negotiated parameters. In other words, power transmitting device 12 may operate in an active wireless power transfer mode. During the active wireless power transfer mode, device 12 may concurrently perform in-band communications with device 24 (e.g., device 12 may use at transmitter in transceiver 20 to transmit FSK packets to a receiver in transceiver 40, whereas device 24 may use a data transmitter in transceiver 40 to transmit ASK packets to a receiver in transceiver 20 while wireless power is being transferred from device 12 to device 24).

Power transmitting device 12 may be operated in the active wireless power transfer mode to charge battery 34 of device 24 until a state of charge (SOC) or battery level of battery 34 is deemed to be full. Power transfer operations can be halted when the state of charge of battery 34 has exceeded a target charging threshold, when the temperature of battery 34 has exceeded a predetermined temperature threshold, or when device 12 otherwise determines that power transmission should be halted. The target charging threshold may, for example, be equal to 80%, 90%, 95%, 99%, or other suitable target threshold value for indicating that battery 58 is near the end of charge or is fully charged. Pausing or halting power transfer operations when battery 34 is fully charged can help reduce power consumption at device 12 while preventing unnecessary charging at device 24 (e.g., constantly topping off battery 34 to 100% state of charge may be excessive especially when device 24 is idle).

The operations of FIG. 6 are illustrative. The operations of power transmitting device 12 can be at least partially carried out or orchestrated by control circuitry 16 of device 12 (see FIG. 1). Operating system 8 in this way by dynamically changing the power adapter (delivery) mode to selectively adjust Vin based on one or more negotiated wireless power transfer operating characteristic or criteria can be technically advantageous and beneficial to allow a DC-DC converter (e.g., a boost converter) within power transmitting device 12 to boost Vin more efficiently, which can help reduce electromagnetic interference and power consumption. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

In accordance with an embodiment, an electronic device is provided that includes a wireless power transfer coil configured to transmit wireless power to a wireless power receiving device, power transmitting circuitry configured to receive an input voltage from a power adapter and to drive corresponding alternating-current (AC) signals through the wireless power transfer coil, and control circuitry configured to negotiate a power level with the wireless power receiving device, detect whether the negotiated power level is below a threshold level, and direct the power adapter to switch from operating in a first power delivery mode to operating in a second power delivery mode in response to detecting that the negotiated power level is below the threshold level, where the input voltage received by the power transmitting circuitry has a first voltage level when the power adapter is operating in the first power delivery mode and has a second voltage level different than the first voltage level when the power adapter is operating in the second power delivery mode.

In accordance with another embodiment, the control circuitry can be further configured to detect whether the negotiated power level falls from a higher power level to below the threshold level and to direct the power adapter to switch from operating in the first power delivery mode to operating in the second power delivery mode in response to detecting that the negotiated power level falls below the threshold level, where the second voltage level can be less than the first voltage level.

In accordance with another embodiment, the electronic device can further include a boost converter configured to boost the received input voltage to generate a corresponding boosted voltage for generating the AC signals through the wireless power transfer coil.

In accordance with another embodiment, the power transmitting circuitry can be operable in a plurality of different power modes, and the negotiated power level can have different values corresponding to the plurality of different power modes.

In accordance with another embodiment, the power adapter can be operable in a third power delivery mode, and the input voltage received by the power transmitting circuitry can have a third voltage level different than the first and second voltage levels when the power adapter is operating in the third power delivery mode.

In accordance with another embodiment, the threshold level can be a selected one of: 3 W, 4 W, 5 W, and 6 W.

In accordance with another embodiment, the power adapter can be a Universal Serial Bus (USB) adapter configured to convert alternating-current (AC) mains electricity to the input voltage, wherein the input voltage comprises direct-current (DC) electricity. The step of directing the power adapter to switch from operating in the first power delivery mode to operating in the second power delivery mode can include sending, by the electronic device, a USB Power Delivery compliant message to the power adapter.

In accordance with another embodiment, the electronic device can further include a boost converter coupled between the power adapter and the power transmitting circuitry and configured to boost the input voltage from the power adapter and to provide the boosted voltage to drive the corresponding alternating-current (AC) signals through the wireless power transfer coil, while the power adapter is operating in the second power delivery mode.

In accordance with an embodiment, a method of operating an electronic device removably coupled to a power adapter is provided that includes negotiating a power level with a wireless power receiving device, detecting whether the negotiated power level is equal to a first power level or is within a first range of power levels, directing the power adapter to operate in a first power delivery mode that delivers a first voltage to one or more inputs of the electronic device in response to detecting that the negotiated power level is equal to the first power level or is within the first range of power levels, and using power transmitting circuitry to transmit wireless power to the wireless power receiving device in accordance with the negotiated power level.

In accordance with another embodiment, the method can further include detecting whether the negotiated power level is equal to a second power level or is within a second range of power levels, and directing the power adapter to operate in a second power delivery mode that delivers a second voltage, different than the first voltage, to the one or more inputs of the electronic device in response to detecting that the negotiated power level is equal to the second power level or is within the second range of power levels.

In accordance with another embodiment, the method can further include detecting whether the negotiated power level is equal to a third power level or is within a third range of power levels, and directing the power adapter to operate in a third power delivery mode that delivers a third voltage, different than the first and second voltages, to the one or more inputs of the electronic device in response to detecting that the negotiated power level is equal to the third power level or is within the third range of power levels.

In accordance with another embodiment, the second power level can be less than the first power level, the second range of power levels can be less than the first range of power levels, and the second voltage can be less than the first voltage.

In accordance with another embodiment, the method can further include using a boost converter to boost the second voltage to generate a corresponding boosted voltage for transmitting wireless power at the negotiated power level.

In accordance with another embodiment, the method can further include detecting whether the negotiated power level is equal to a second power level or is within a second range of power levels and reducing electromagnetic interference or power loss by directing the power adapter to operate in a second power delivery mode that delivers a second voltage less than the first voltage in response to detecting that the negotiated power level is equal to the second power level or is within the second range of power levels.

In accordance with an embodiment, a system is provided that includes a power receiving device, a power adapter, and a power transmitting device coupled to the power adapter. The power transmitting device includes a wireless power transfer coil configured to transmit wireless power to the power receiving device, power transmitting circuitry configured to receive an input voltage from the power adapter and to drive corresponding alternating-current (AC) signals through the wireless power transfer coil, and control circuitry configured to negotiate a power level with the power receiving device, determine whether the power level crosses a threshold, is equal to a first power level, or is within a first range of power levels, and control the power adapter based on whether the power level crosses the threshold, is equal to the first power level, or is within the first range of power levels.

In accordance with another embodiment, the control circuitry can be further configured to determine whether the power level falls below the threshold and adjust the power adapter so that the power adapter delivers a reduced voltage to one or more inputs of the power transmitting device in response to determining that the power level has fallen below the threshold.

In accordance with another embodiment, the power transmitting device can further include a boost converter configured to step up the reduced voltage received at the one or more inputs.

In accordance with another embodiment, the control circuitry can be further configured to direct the power adapter to deliver a first voltage to one or more inputs of the power transmitting device in response to determining that the power level is equal to the first power level or is within the first range of power levels.

In accordance with another embodiment, the control circuitry can be further configured to determine whether the power level is equal to a second power level or is within a second range of power levels and direct the power adapter to deliver a second voltage, different than the first voltage, to the one or more inputs of the power transmitting device in response to determining that the power level is equal to the second power level or is within the second range of power levels.

In accordance with another embodiment, the control circuitry can be further configured to determine whether the power level is equal to a third power level or is within a third range of power levels and direct the power adapter to deliver a third voltage, different than the first and second voltages, to the one or more inputs of the power transmitting device in response to determining that the power level is equal to the third power level or is within the third range of power levels.

The foregoing is merely illustrative and various modifications can be made to the described embodiments. The foregoing embodiments may be implemented individually or in any combination.

What is claimed is:

1. A power transmitting device comprising:
a wireless power transfer coil configured to transmit wireless power to a power receiving device;
power transmitting circuitry configured to receive an input voltage from a power adapter and to drive corresponding alternating-current (AC) signals through the wireless power transfer coil; and
control circuitry configured to:
negotiate a target operating characteristic with the power receiving device; and
direct the power adapter to adjust the input voltage based on the target operating characteristic.

2. The power transmitting device of claim 1, wherein the control circuitry is further configured to receive one or more messages from the power receiving device that indicate the target operating characteristic.

3. The power transmitting device of claim 1, wherein the power transmitting circuitry is configured to receive the input voltage adjusted based on the target operating characteristic and drive the AC signals through the wireless power transfer coil at the adjusted input voltage.

4. The power transmitting device of claim 2, wherein:
the target operating parameter comprises a target power mode selected from among a plurality of power modes;
a first power mode in the plurality of power modes comprises a power mode that is used when the power transmitting device begins transmitting wireless power to the power receiving device; and
a second power mode in the plurality of power modes comprises a power mode that is negotiated by the power receiving device when a battery level at the power receiving device exceeds a first battery threshold.

5. The power transmitting device of claim 4, wherein a third power mode in the plurality of power modes comprises a power mode that is negotiated by the power receiving device when the battery level at the power receiving device is below a second battery threshold.

6. The power transmitting device of claim 1, further comprising:
a rectifier coupled to the wireless power transfer coil, wherein the target operating characteristic comprises a target rectifier voltage produced by the rectifier and wherein the control circuitry is further configured to adjust the input voltage to a first voltage level when the target rectifier voltage comprises a first value and adjust the input voltage to a second voltage level, different than the first voltage level, when the target rectifier voltage comprises a second value.

7. The power transmitting device of claim 1, further comprising:
a rectifier coupled to the wireless power transfer coil, wherein the target operating characteristic comprises a target rectifier power produced by the rectifier and wherein the control circuitry is further configured to adjust the input voltage to a first voltage level when the target rectifier power comprises a first value and adjust the input voltage to a second voltage level, different than the first voltage level, when the target rectifier power comprises a second value.

8. The power transmitting device of claim 1, further comprising:
a boost converter coupled between the power adapter and the power transmitting circuitry and configured to boost the input voltage from the power adapter and to provide the boosted voltage to drive the corresponding alternating-current (AC) signals through the wireless power transfer coil.

9. The power transmitting device of claim 1, wherein the power adapter comprises a Universal Serial Bus (USB) adapter configured to convert alternating-current (AC) mains electricity to the input voltage, wherein the input voltage comprises direct-current (DC) electricity, and wherein the power transmitting device is configured to send a USB Power Delivery compliant message to the power adapter for directing the power adapter to adjust the input voltage based on the target operating characteristic.

10. A method of operating a power transmitting device coupled to a power adapter, the method comprising:
negotiating a target operating characteristic with a power receiving device;
directing the power adapter to deliver an input voltage having a voltage level that is based on the target operating characteristic, wherein the input voltage is delivered to one or more inputs of the power transmitting device; and
with power transmitting circuitry, transmitting wireless power to the power receiving device while the input voltage is being delivered to the one or more inputs of the power transmitting device.

11. The method of claim 10, wherein negotiating the target operating characteristic with the power receiving device comprises receiving a packet from the power receiving device, the packet comprising the target operating characteristic.

12. The method of claim 10, wherein the target operating characteristic comprises one or more of: a target power mode, a target rectifier voltage, a target rectifier power, and a target rectifier current.

13. The method of claim 11, wherein:
the target power mode is selected from among a plurality of power modes;
a first power mode in the plurality of power modes comprises a power mode that is used when the power transmitting device begins transmitting wireless power to the power receiving device; and
a second power mode in the plurality of power modes comprises a power mode that is negotiated by the power receiving device in response to detecting a first condition at the power receiving device.

14. The method of claim 13, wherein a third power mode in the plurality of power modes comprises a power mode that is negotiated by the power receiving device in response to detecting a second condition, different than the first condition, at the power receiving device.

15. The method of claim 12, further comprising:
in response to determining that the target rectifier voltage has a first value, directing the power adapter to adjust the voltage level of the input voltage to a first voltage level; and
in response to determining that the target rectifier voltage has a second value, directing the power adapter to adjust the voltage level of the input voltage to a second voltage level different than the first voltage level.

16. The method of claim 12, further comprising:
in response to determining that the target rectifier power has a first value, directing the power adapter to adjust the voltage level of the input voltage to a first voltage level; and
in response to determining that the target rectifier power has a second value, directing the power adapter to adjust the voltage level of the input voltage to a second voltage level different than the first voltage level.

17. A system comprising:
a power receiving device;
a power adapter; and
a power transmitting device coupled to the power adapter, wherein the power transmitting device comprises:
a wireless power transfer coil configured to transmit wireless power to the power receiving device;
power transmitting circuitry configured to receive an input voltage from the power adapter and to drive corresponding alternating-current (AC) signals through the wireless power transfer coil; and
control circuitry configured to:
receive information from the power receiving device; and
direct the power adapter to adjust the input voltage based on the information received from the power receiving device.

18. The system of claim 17, wherein the information received from the power receiving device comprises a target operating characteristic selected from one or more of: a target power mode, a target rectifier voltage, a target rectifier power, and a target rectifier current.

19. The system of claim 17, wherein:
the target power mode is selected from among a plurality of power modes;
a first power mode in the plurality of power modes comprises a power mode that is used when the power transmitting device begins transmitting wireless power to the power receiving device;
a second power mode in the plurality of power modes comprises a power mode that is negotiated by the power receiving device in response to detecting a first condition at the power receiving device; and
a third power mode in the plurality of power modes comprises a power mode that is negotiated by the power receiving device in response to detecting a second condition, different than the first condition, at the power receiving device.

20. The system of claim 17, wherein the power adapter comprises a Universal Serial Bus (USB) adapter configured to convert alternating-current (AC) mains electricity to the input voltage, wherein the input voltage comprises direct-current (DC) electricity, and wherein the power transmitting device is configured to send a USB Power Delivery compliant message to the power adapter for directing the power adapter to adjust the input voltage based on the information received from the power receiving device.
